(19) United States
(12) Patent Application Publication
(10) Pub. No.: US 2009/0083359 A1
(43) Pub. Date: Mar. 26, 2009

(54) APPARATUS FOR CALCULATING SQUARE ROOT

(75) Inventors: Kang Joo KIM, Yongin (KR); Bong Soon KANG, Busan (KR); Won Woo JANG, Busan (KR); Hyun Soo KIM, Busan (KR); Won Tae CHOI, Hwaseong (KR)

Correspondence Address: LOWE HAUPTMAN HAM & BERNER, LLP, 1700 DIAGONAL ROAD, SUITE 300, ALEXANDRIA, VA, 22314, US

(73) Assignee: Samsung Electro-Mechanics Co., Ltd., SUWON (KR)

(21) Appl. No.: 12/211,375

(22) Filed: Sep. 16, 2008

(30) Foreign Application Priority Data
Sep. 21, 2007 (KR) 10-2007-0097022

(51) Int. Cl. G06G 7/20

(52) U.S. Cl. 708/605

(57) ABSTRACT

Provided is a square root calculation apparatus. The apparatus includes a section judgment unit, a coefficient storing unit, and an adder. The section judgment unit stores information regarding a plurality of sections obtained by dividing an entire range of an input value into predetermined intervals, and judges one of the sections to which the input value belongs when the input value is input. The coefficient storing unit stores, in advance, first-order term coefficients and constant terms of first-order approximate equations obtained by approximating square root curves for respective sections, multiplies a first-order term coefficient of the first-order approximate equation in the section to which the input value belongs, by the input value to output a first-order term, and outputs a constant term in the section to which the input value belongs. The adder adds the first-order term and the constant term output from the coefficient storing unit to calculate an approximated square root value.

### CROSS-REFERENCE TO RELATED APPLICATIONS

This application claims the priority of Korean Patent Application No. 2007-97022 filed on Sep. 21, 2007 in the Korean Intellectual Property Office, the disclosure of which is incorporated herein by reference.

### BACKGROUND OF THE INVENTION

1. Field of the Invention

The present invention relates to an apparatus and a method for calculating a square root, and more particularly, to an apparatus and a method for calculating a square root, that obtains a coefficient of a first-order equation obtained by approximating a square root curve using a linear regression analysis and storing the same, and then calculates a square root using the stored coefficient of the linear equation.

2. Description of the Related Art

A generally known related art square root calculation method is roughly classified into two.

A first related art square root calculation method obtains an approximate value of a square root using a look-up table such as a table of square roots. In this method, a maximum range of an arbitrary input value is designated, square root values for values within the maximum range of the input value are stored in a look-up table in advance, and when there exists an input value, an approximate value for the input value is searched for from the look-up table and output. Such a square root calculation method using the look-up table has a limitation that as the size of an input value, i.e., the bit of the input value increases, the size of a memory storage space for storing approximate values of a square root increases by geometric progression. That is, when the bit of an input value increases by 1 bit, the size of a memory storage space increases by time times. For example, in the case where the bit of an input value is 21 bits, a maximum value of an input value is 2097152 (=2²¹), and the number of output bits is 11 bits, a memory storage space for storing a look-up table requires a space of 2²¹×11 bits. As described above, when an input value increases beyond a predetermined range, a very large memory storage space is required, the method of obtaining an approximate value of a square root using a look-up table is difficult to apply to the case where the range of an input value is large.

A second related art square root calculation method obtains an approximate value of a square root repeatedly using the four fundamental arithmetic operations of addition, subtraction, multiplication, and division. In other words, to obtain a square root of an input value, the four fundamental arithmetic operations are repeatedly used to reduce an error between output data and an exact square root, so that the output value approximates to the exact square root. Such a square root calculation method can obtain a more exact square root because it can reduce an error between output data and the exact square root as it repeats the four fundamental arithmetic operations even more. However, when the frequency of repetition of the four fundamental arithmetic operations is increased, power consumption due to the repeated operations increases. That is, the square root calculation method that repeats the four fundamental arithmetic operations is difficult to apply to a system requiring low power consumption. In addition, since the square root calculation method that repeats the four fundamental arithmetic operations has a long operation time due to repeated operation performance, such a method is difficult to apply to a system requiring a high speed operation.

### SUMMARY OF THE INVENTION

An aspect of the present invention provides a square root calculation method using a linear regression analysis, that does not require a large memory storage space, consumes low power, perform a high speed operation, and can minimize an error.

According to an aspect of the present invention, there is provided a square root calculation apparatus including: a section judgment unit storing information regarding a plurality of sections obtained by dividing an entire range of an input value which is an object of square root calculation, into predetermined intervals, and judging one of the sections to which the input value belongs when the input value is input; a coefficient storing unit storing, in advance, first-order term coefficients and constant terms of first-order approximate equations obtained by approximating square root curves for respective sections, multiplying a first-order term coefficient of the first-order approximate equation in the section to which the input value belongs, judged by the section judgment unit, by the input value to output a first-order term, and outputting a constant term in the section to which the input value belongs, judged by the section judgment unit; and an adder adding the first-order term and the constant term output from the coefficient storing unit to calculate an approximated square root value.

A first-order term coefficient and a constant term of a first-order approximate equation in each of the sections may be determined by linear regression analysis.

The first-order approximate equations may be calculated by dividing the entire range of the input value into the plurality of sections such that adjacent sections overlap each other, and applying linear regression analysis to respective overlapping sections. The plurality of sections stored in the section judgment unit may include sections divided using intersection points of the first-order approximate equations as boundaries, determined in the overlapping sections adjacent to each other.

The plurality of sections stored in the section judgment unit may have a close interval when an input value is close to zero, and have a wide interval when the input value is large.

The coefficient storing unit may include: a first-order term output unit selecting a first-order term coefficient for the section to which the input value belongs from the first-order term coefficients of the first-order approximate equations for respective sections, and multiplying the selected first-order term coefficient by the input value to output the same; a constant term output unit selecting the constant term of the section to which the input value belongs, from the constant terms of the first-order approximate equations for the respective sections to output the same; and a control signal generator outputting a control signal including information regarding the section to which the input value belongs, to the first term output unit and the constant term output unit in order to determine the coefficient in the section to which the input value belongs using the information regarding the section to which the input value belongs.

The first-order term output unit may include: a bit moving unit bit-moving the input value to an upper bit by each number of bits up to a maximum bit set in advance; a multiplexer unit including a plurality of multiplexers selecting some of values bit-moved by the bit moving unit to output the same; and an adder adding value output from the multiplexer unit, the control signal including information regarding the bit-moved value that is to be selected by the plurality of multiplexers according to the section to which the input value belongs, determined by the section judgment unit.

The constant term output unit may include: a storing unit storing a constant term of a first-order approximate equation according to the section; and a multiplexer selecting the constant term of the first-order approximate equation in the section to which the input value belongs, from the storing unit and outputting the same in response to the control signal.

According to the present invention, a section is subdivided depending on the size of an input value, which is an object of square root calculation, and a first-order approximate equation that minimizes an error using linear regression analysis is obtained for each section and applied to square root calculation, so that complexity of square root calculation is reduced and simultaneously accuracy is improved.

Also, according to the present invention, since only a first-order term coefficient and a constant term value of a first-order approximate equation are stored, a large storage space is not required. Since a complex operation is excluded through simple operations of a bit movement operation and addition, power consumption is reduced and an operation time can be reduced.

In addition, according to the present invention, a section for obtaining a first-order approximate equation is selected such that adjacent sections overlap each other, so that an error between the first-order approximate equation and an exact square root curve can be minimized.

In addition, according to the present invention, multiplication of a first-order term coefficient and an input value is performed using a simple bit movement operation method in applying an input value to a first-order approximate equation, so that application of a multiplier is excluded and so a square root calculation apparatus can be miniaturized.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram of a square root calculating apparatus according to an embodiment of the present invention;

FIG. 2 is a view illustrating a square root curve divided into thirty one divisions according to an embodiment of the present invention;

FIGS. 3 and 4 are views explaining a method of approximating a specific section of a square root curve using linear regression analysis to express the section using a first-order approximate equation;

FIG. 5 illustrates an example where the entire range of an input value is divided into three sections, which dot not overlap between each other;

FIGS. 6A through 6C are views illustrating adjacent sections of an entire section of an input value are divided into three overlapping sections, and an approximate equation is obtained for each section;

FIGS. 7A and 7B are views briefly explaining concept of a bit movement operation; and

FIGS. 8 and 9 are views illustrating the detailed construction of a first-order term output unit according to an embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the shapes and sizes of elements may be exaggerated for clarity.

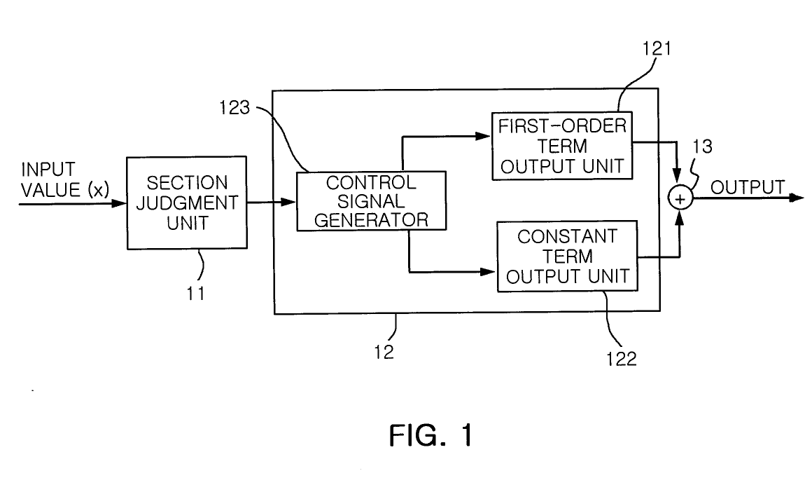

FIG. 1 is a block diagram of a square root calculating apparatus according to an embodiment of the present invention. Referring to FIG. 1, the square root calculating apparatus can include a section judgment unit 11, a coefficient storing unit 12, and an adder 13.

The section judgment unit 11 can store information regarding a plurality of sections obtained by dividing an entire range of an input value x, which becomes an object of square root calculation, into predetermined intervals. Also, when an input value x is input for square root calculation, the section judgment unit 11 judges a section of the sections to which the input value x belongs.

The coefficient storing unit 12 can store, in advance, first-order term coefficients and constant terms of first-order approximate equations obtained by approximating a square root curve for respective sections, multiplies a first-order term coefficient of the first-order approximate equation in a section to which the input value belongs, judged by the section judgment unit 11, by the input value to output a first-order term, and outputs a constant term in the section to which the input value belongs, judged by the section judgment unit 11.

The coefficient storing unit 12 can include a first-order term output unit 121 performing an operation on a first-order term of the first-order approximate equation, and outputting the same, a constant term output unit 122 outputting a constant term of the first-order approximate equation, and a control signal generator 123 providing information regarding a section to which an input value x, an object of square root calculation, belongs to the first-order term output unit 121 and the constant term output unit 122.

The adder 13 adds the first-order term and the constant term output from the coefficient storing unit to calculate an approximate square root value.

In the operation of the embodiment, the section judgment unit 11 can determine a section to which an input value x whose square root is to be calculated belongs.

In order to determine a section to which the input value x belongs, the section judgment unit 11 can store, in advance, section information obtained by an entire range to which the input value x can belong into a plurality of sections, and determine a section of the sections stored in advance to which a currently input value x belongs in order to calculate square root. In the present invention, a first-order approximate equation obtained by approximating an exact square root curve (f(x)=\sqrt{x}) of a section is determined and used for respective sections. Therefore, the section can be appropriately determined such that an error between the first-order approximate equation and the exact square root curve is minimized. Particularly, since the shape of a square root curve is provided such that a change in the size of a square root value is large as an input value x is small (i.e., the input value is close to zero), the section may be divided into smaller subdivisions as the input value x is small. That is, as the input value x is a small region, the range of the section may be set to a small region.

For example, in the case where the input value x has a range of 0-2097151 up to a maximum of 21 bits, ranges for respective sections of the input value x can be determined as in Table 1.

TABLE 1

| Section | Range |
|---|---|
| 1 | 1-2 |
| 2 | 3-112 |
| 3 | 112-850 |
| 4 | 850-1800 |
| 5 | 1800-3800 |
| 6 | 3800-7200 |
| 7 | 7200-14500 |
| 8 | 14500-21000 |
| 9 | 21000-37000 |
| 10 | 37000-41010 |
| 11 | 41010-46010 |
| 12 | 46010-52000 |
| 13 | 52000-74000 |
| 14 | 74000-82720 |
| 15 | 82720-91400 |
| 16 | 91400-100000 |
| 17 | 100000-140000 |
| 18 | 140000-194000 |
| 19 | 194000-240000 |
| 20 | 240000-300000 |
| 21 | 300000-399880 |
| 22 | 399880-500000 |
| 23 | 500000-600000 |
| 24 | 600000-730200 |
| 25 | 730200-923000 |
| 26 | 923000-1100000 |
| 27 | 1100000-1300000 |
| 28 | 1300000-1500000 |
| 29 | 1500000-1730000 |
| 30 | 1730000-2017000 |
| 31 | 2017000-2097151 |

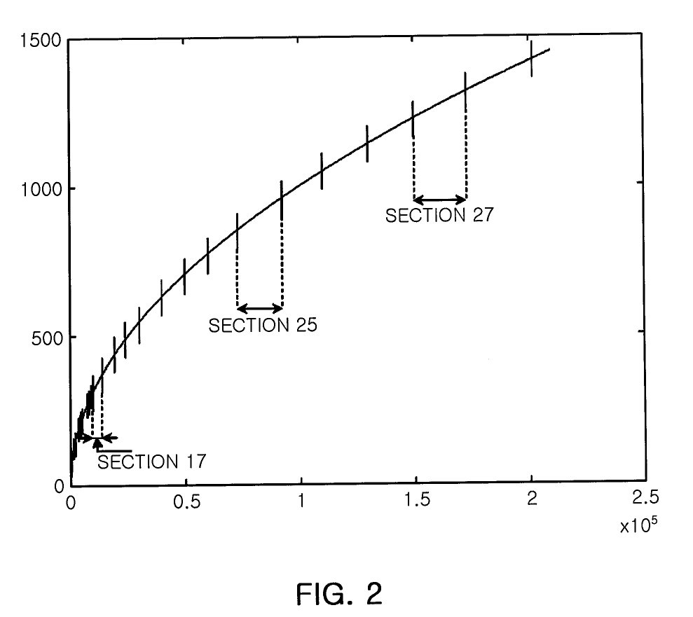

In Table 1, an entire range to which an input value x can belong is divided into 31 sections in order to minimize a range of an error, and the 31 sections are illustrated in the square root curve of FIG. 2. As illustrated in FIG. 2, since an amount of change of the square root curve is large in a region where an input value x is small, a range of one section is set small. Also, since an amount of change of the square root curve is small in a region where an input value x is large, a range of one section is set large. A method of determining a boundary of each section with respect to an input value stored in the section judgment unit 11 is described in more detail later.

Next, coefficients of first-order approximate equations for an exact square root curve in respective sections stored in the section judgment unit 11 can be stored in the coefficient storing unit 12. That is, the coefficient storing unit 12 can calculate and store, in advance, coefficients of first-order approximate equations that can optimally approximate a square root value of a section for respective sections stored in the section judgment unit 11.

According to the present invention, linear regression analysis can be used to calculate coefficients of first-order approximate equations for respective sections stored in the coefficient storing unit 12. That is, coefficients of first-order equations that can approximate a square root with a minimum error is calculated in advance using linear regression analysis for each section of an input value, and the calculated coefficients can be stored in the coefficient storing unit 12.

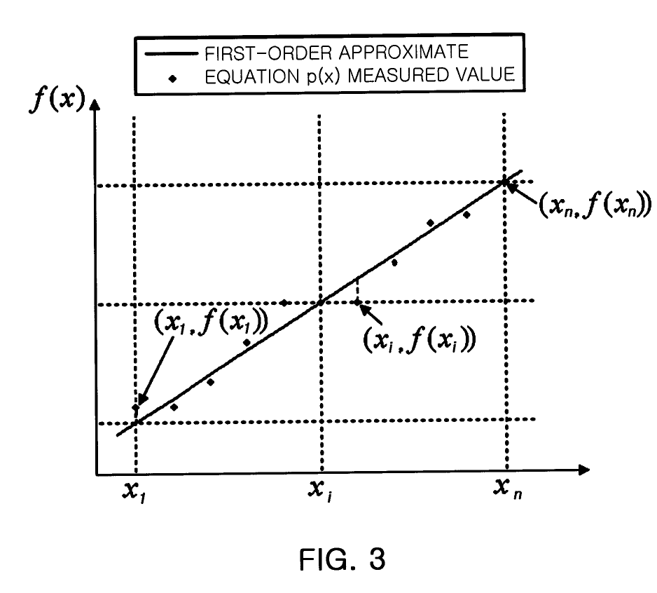

FIG. 3 is a view explaining a method of approximating a measured value (an exact square root value in the present invention) using linear regression analysis to express the measured value using a first-order approximate equation. Referring to FIG. 3, in the case where measured values at x₁ through xₙ, which belong to a section of an input value x, are f(x₁) through f(xₙ), a method of obtaining a first-order approximate equation (p(x)=a₁x+a₀) using linear regression analysis is described.

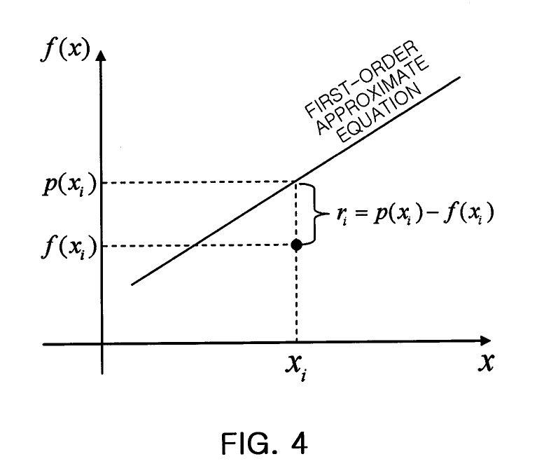

Linear regression analysis is a method of minimizing sum of errors of all given data in order to obtain an optimized first-order approximate equation in a simplest form with respect to measured values during least square approximation. That is, when measured values for x₁ through xₙ, which are respective input values, are f(x₁) through f(xₙ), and a first-order approximate equation p(x) has a form of p(x)=a₁x+a₀, linear regression analysis is a method of minimizing sum of squares of rᵢ(=p(xᵢ)−f(xᵢ)), which is an error between a measured value f(xᵢ) and an approximate value p(xᵢ) by the first-order approximate equation as illustrated in FIG. 4. Linear regression analysis can be expression by equation below in which S is minimized.

$$\begin{matrix}S = {\sum }_{i = 1}^{n} {r}_{i}^{2} = {\sum }_{i = 1}^{n} {( p ( {x}_{i} ) - f ( {x}_{i} ) )}^{2} \\ = {\sum }_{i = 1}^{n} {( {a}_{1} {x}_{i} + {a}_{0} - f ( {x}_{i} ) )}^{2}\end{matrix} \qquad Equation 1$$

To minimize S of Equation 1, a partial differentiation function of Equation 1 should be zero as in Equation 2.

$$\frac{\partial S}{\partial {a}_{j}} = 0 \qquad Equation 2$$

Therefore, partial differentiation of Equation 1 is taken with respect to a₁ and a₀, which are coefficients of the first-order approximate equation p(x), such that the partial differentiation is equal to zero as in Equation 3 below.

$$\begin{matrix}\frac{\partial S}{\partial {a}_{0}} = 2 {\sum }_{i = 1}^{n} ( {a}_{0} + {a}_{1} {x}_{i} - f ( {x}_{i} ) ) = 0 \\ \frac{\partial S}{\partial {a}_{1}} = 2 {\sum }_{i = 1}^{n} ( {a}_{0} + {a}_{1} {x}_{i} - f ( {x}_{i} ) ) {x}_{i} = 0\end{matrix} \qquad Equation 3$$

Equation 3 can be expanded and expressed as in Equation 4.

$${a}_{0} n + {a}_{1} {\sum }_{i = 1}^{n} {x}_{i} = {\sum }_{i = q}^{n} f ( {x}_{i} ) \\ {a}_{0} {\sum }_{i = 1}^{n} {x}_{i} + {a}_{1} {\sum }_{i = 0}^{n} {x}_{i}^{2} = {\sum }_{i = 0}^{n} f ( {x}_{i} ) {x}_{i} \qquad Equation 4$$

Equation 4 can be expressed in a matrix-vector method as in Equation 5 below.

$$[ \begin{matrix}n & {\sum }_{i = 1}^{n} {x}_{i} \\ {\sum }_{i = 1}^{n} {x}_{i} & {\sum }_{i = 1}^{n} {x}_{i}^{2}\end{matrix} ] [ \begin{matrix}{a}_{0} \\ {a}_{1}\end{matrix} ] = [ \begin{matrix}{\sum }_{i = 1}^{n} f ( {x}_{i} ) \\ {\sum }_{i = 1}^{n} f ( {x}_{i} ) {x}_{i}\end{matrix} ] \qquad Equation 5$$

Assuming that

$$[ \begin{matrix}n & {\sum }_{i = 1}^{n} {x}_{i} \\ {\sum }_{i = 1}^{n} {x}_{i} & {\sum }_{i = 1}^{n} {x}_{i}^{2}\end{matrix} ] = A , [ \begin{matrix}{a}_{0} \\ {a}_{1}\end{matrix} ] = C , and [ \begin{matrix}{\sum }_{i = 1}^{n} f ( {x}_{i} ) \\ {\sum }_{i = 1}^{n} f ( {x}_{i} ) {x}_{i}\end{matrix} ] = B ,$$

Equation 5 becomes A·C=B. Therefore, coefficients a₀ and a₁ of the first-order approximate equation p(x) can be obtained by C=A⁻¹·B (A⁻¹ is an inverse function of A).

When a method of determining coefficients of a first-order approximate equation using the above-described linear regression analysis is applied, the coefficients a₀ and a₁ of the first-order approximate equation obtained by approximating an exact square root curve in respective sections stored in the section judgment unit 11 can be expressed by Equation 6 below.

$$[ \begin{matrix}{a}_{0} \\ {a}_{1}\end{matrix} ] = {[ \begin{matrix}n & {\sum }_{i = 1}^{n} {x}_{i} \\ {\sum }_{i = 1}^{n} {x}_{i} & {\sum }_{i = 1}^{n} {x}_{i}^{2}\end{matrix} ]}^{- 1} [ \begin{matrix}{\sum }_{i = 1}^{n} f ( {x}_{i} ) \\ {\sum }_{i = 1}^{n} f ( {x}_{i} ) {x}_{i}\end{matrix} ] \qquad Equation 6$$

where a₀ is a constant term of the first-order approximate equation, a₁ is a coefficient of a first-order term of the first-order approximate equation, n is the size (integer) of a section, xᵢ is an input value included in the section, and f(xᵢ) is a square root value of xᵢ.

In the present invention, coefficients of first-order approximate equations obtained by approximating square roots for respective sections divided from an entire range of an input value can be calculated in advance using Equation 6, and stored in the coefficient storing unit 12 in advance. By doing so, when an input value whose square root is to be calculated is input, the present invention judges only a section to which the input value belongs, can calculate an optimized first-order approximate equation for the relevant section, and calculate a square root using a simple method of inputting the input value into the first-order approximate equation.

Hereinafter, a section determining method that can minimize an error between an exact square root value and a first-order approximate equation obtained by approximating the square root value is described in detail.

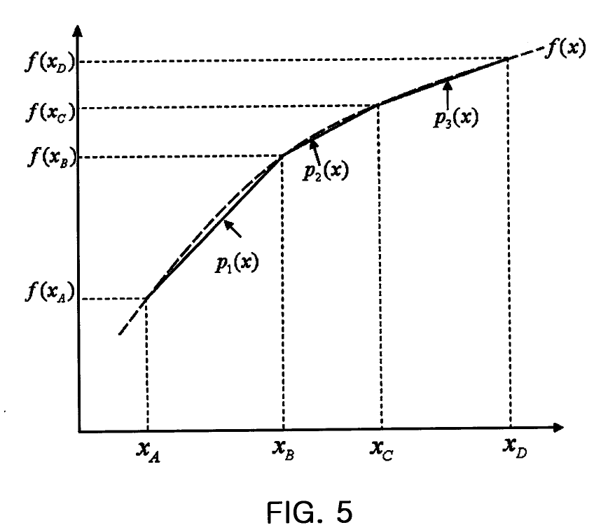

As described above, the present invention uses a method of dividing the entire range of an input value into a plurality of sections, and obtaining first-order approximate equations for respective sections, thereby minimizing an error between an exact square root value and the first-order approximate equation. FIG. 5 illustrates an example where the entire range [x_{A}, X_{D}] of an input value is divided into three sections, which are [X_{A}, X_{B}], [X_{B}, X_{C}], and [X_{C}, X_{D}] . First-order approximate equations p₁(x), P₂(x), and p₃(x) can be obtained by applying the above-described linear regression analysis for the respective sections. A function f(x) can be approximated and expressed by Equation 7 below using the above-obtained first-order approximate equations.

f(x)≅p(x)=p₁(x)|ₓ₌ₓ_{_{A}}^{x=x}^{_{B}}+p₂(x)|ₓ₌ₓ_{_{B}}^{x=x}^{_{C}}+p₃(x)|ₓ₌ₓ_{_{C}}^{x=x}^{_{D}} Equation 7

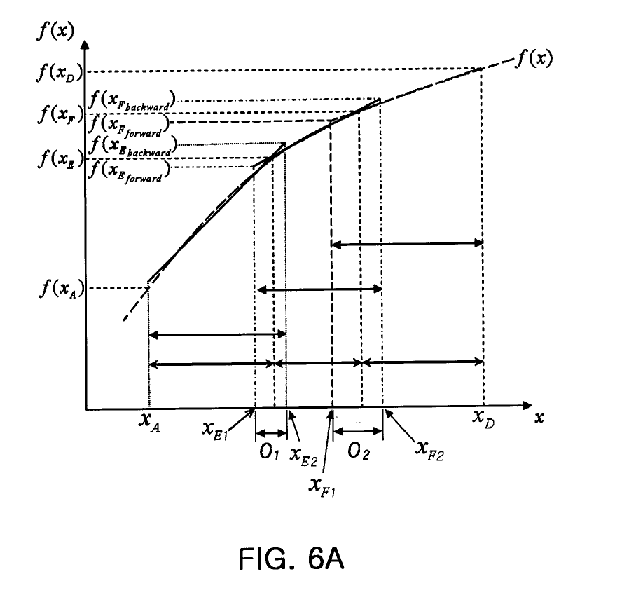

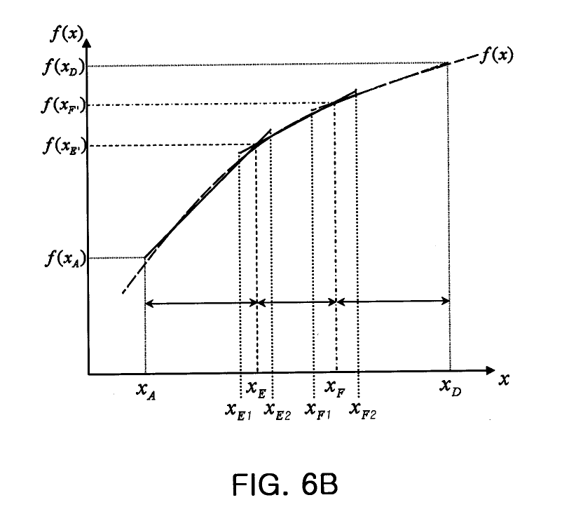

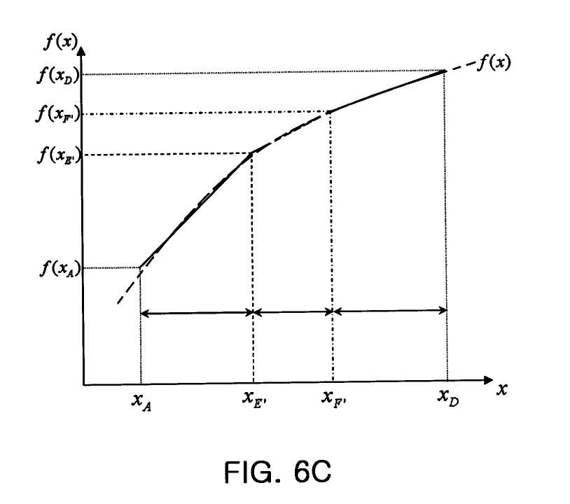

The present invention adopts a method of dividing a range into sections such that adjacent sections overlap each other, and obtaining first-order approximate equations for respective overlapping sections using the above-described linear regression method in order to achieve more precise approximation compared to the simple section determining method expressed by FIG. 5 and Equation 7. A method of determining an approximate equation through selection of the overlapping sections is illustrated in FIGS. 6A to 6C.

First, as illustrated in FIG. 6A, a section of an input value x is determined such that adjacent sections overlap each other. In FIG. 6A, a first section can be determined as a range from x_{A} to x_{E2}, a second section can be determined as a range from x_{E1} to x_{F2}, a third section can be determined as a range from x_{F1} to x_{D}. Through the section determination, regions corresponding to [x_{E1}, x_{E2}] and [x_{F1}, x_{F2}] become overlapping regions of the sections.

Subsequently, as illustrated in FIG. 6B, first-order approximate equations obtained by approximating a function f (x), which is an object of approximation, are obtained for the respective sections using the above-described linear regression analysis. Since these first-order approximate equations are obtained with the respective section overlapping each other, two first-order approximate equations exist in the overlapping regions [x_{E1}, x_{E2}] and [x_{F1}, x_{F2}] of the respective sections. Since the present invention intends to obtain an approximate equation with a small error with respect to the function f(x), a first-order approximate equation where an error with respect to the function f(x) is a minimum may be selected in the overlapping regions [x_{E1}, x_{E2}] and [x_{F1}, x_{F2}]. Referring to approximate equations in the overlapping regions [x_{E1}, x_{E2}] and [x_{F1}, x_{F2}] illustrated in FIG. 6B, it is known that approximate equations before and after an intersection point of the two approximate equations as a boundary have a minimum error. In the first overlapping region [x_{E1}, x_{E2}], p′₁(x) can be selected as a first-order approximate equation in a region smaller than an x value (x_{E}) of the intersection point of the two approximate equations, and p′₂(x) can be selected as a first-order approximate equation in a region greater than an x value (x_{E}) of the intersection point of the two approximate equations. Likewise, in the second overlapping region [x_{F1}, x_{F2}], p′₂(x) can be selected as a first-order approximate equation in a region smaller than an x value (x_{F}) of the intersection point of the two approximate equations, and p′₄(x) can be selected as a first-order approximate equation in a region greater than an x value (x_{F}) of the intersection point of the two approximate equations. As described above, after sections determined such that they have overlapping regions are selected, approximate equations are obtained in the overlapping regions, and a new section can be determined from an x value of the intersection point of the approximate equations. These new sections are stored in the section judgment unit 11 and can be used in judging a section of an input value being input.

FIG. 6C illustrates a first-order approximate equation finally calculated by section determination having an overlapping region, which is expressed by Equation 8 below.

f(x)≅p′(x)=p′₁(x)|ₓ₌ₓ_{_{A}}^{x=x}^{_{E}}+p′₂(x)|ₓ₌ₓ_{_{E}}^{x=x}^{_{F}}+p′₃(x)|ₓ₌ₓ_{_{F}}^{x=x}^{_{D}} Equation 8

Comparison of the approximate equations illustrated in FIG. 6C with the approximate equations of FIG. 5 illustrating the approximate equations calculated from sections selected such that they do not have overlapping regions shows that the approximate equations calculated from sections selected such that they have overlapping regions have a smaller error with respect to the function f(x).

For example, in the case where an input value x has a range up to 21 bits at the maximum, a range for each section of the input value x having an overlapping range can be determined as in Table 2, and a section set again using an intersection point in the overlapping region of first-order approximate equations calculated through linear regression analysis in the section of Table 2 can be given by Table 1. That is, as in Table 2, a section determined again by an intersection point of first-order approximate equations in the process of setting overlapping regions and obtaining the first-order approximate equations using optimal approximation through the above-described linear regression analysis, can be given by Table 1.

TABLE 2

| Section | Range |
|---|---|
| 1 | 1-2 |
| 2 | 3-120 |
| 3 | 50-950 |
| 4 | 400-2200 |
| 5 | 1180-4380 |
| 6 | 2950-8050 |
| 7 | 6500-15000 |
| 8 | 13500-22300 |
| 9 | 20000-39000 |
| 10 | 30000-43000 |
| 11 | 39000-47000 |
| 12 | 43500-53000 |
| 13 | 48000-76000 |
| 14 | 63000-85000 |
| 15 | 76500-94500 |
| 16 | 80000-105000 |
| 17 | 84000-150000 |
| 18 | 120000-200000 |
| 19 | 150000-260000 |
| 20 | 220000-307000 |
| 21 | 270000-400000 |
| 22 | 335000-550000 |
| 23 | 445000-645000 |
| 24 | 518000-770000 |
| 25 | 650000-940000 |
| 26 | 855000-1160000 |
| 27 | 940000-1350000 |
| 28 | 1200000-1515000 |
| 29 | 1400000-1760000 |
| 30 | 1650000-2060000 |
| 31 | 1900000-2097151 |

Meanwhile, as a method of obtaining a coefficient of a first-order equation using linear regression analysis, a polynomial function can be made using a MATLAB, which is a mathematical operation tool. The polynomial function is a function for obtaining coefficients a₀, a₁, . . . aₘ) of a simultaneous equation with (m+1) unknowns through polynomial regression analysis. The function is expressed by “function C=polynomial (c,x,m)” on MATLAB. Here, n of Equation 6 can be obtained from c, and f(x₁) of Equation 6 can be obtained through operation of c and x. Also, m of a polynomial function represents the order of a polynomial. Since a coefficient of a first-order equation should be obtained in the present invention, a coefficient of the first-order equation is obtained with m=1. Table 3 illustrates coefficients a₀ and a₁ of a first-order equation obtained by calculating coefficients for 31 respective sections using a polynomial function on the basis of an overlapping section of Table 2, and then changing the coefficients into integers within a range of minimizing an error. In Table 3, a process of changing coefficients of a first-order equation into integers is for realizing hardware. It is noted that a coefficient of a first-order term is multiplied by 2¹⁵, and a coefficient of a second-order term is multiplied by 2⁵ to change the coefficients of the first-order equation including a decimal point into integers. Therefore, values output from the first-order term output unit 121 and the constant term output unit 122 are divided again by the above multiplying numbers. It is noted that operations such as multiplication and division with respect to the above-described coefficients are arbitrarily performed for convenience in operating hardware, and they have nothing to do with the spirit of the present invention.

TABLE 3

Coefficient

| section | a₀ | a₁ |
|---|---|---|
| 1 | 0 | 32768 |
| 2 | 97 | 2336 |
| 3 | 296 | 800 |
| 4 | 526 | 480 |
| 5 | 795 | 320 |
| 6 | 1144 | 224 |
| 7 | 1616 | 160 |
| 8 | 2024 | 128 |
| 9 | 2702 | 96 |
| 10 | 2657 | 96 |
| 11 | 3953 | 64 |
| 12 | 4021 | 64 |
| 13 | 4079 | 64 |
| 14 | 4049 | 64 |
| 15 | 3998 | 64 |
| 16 | 4660 | 56 |
| 17 | 5434 | 48 |
| 18 | 6528 | 40 |
| 19 | 7256 | 36 |
| 20 | 8177 | 32 |
| 21 | 9333 | 28 |
| 22 | 10894 | 24 |
| 23 | 11908 | 22 |
| 24 | 13081 | 20 |
| 25 | 14542 | 18 |
| 26 | 16353 | 16 |
| 27 | 17449 | 15 |
| 28 | 18698 | 14 |
| 29 | 20134 | 13 |
| 30 | 21813 | 12 |
| 31 | 21779 | 12 |

The coefficients a₀ and a₁ obtained by the above process are stored in the coefficient storing unit 12, which calculates product of a first-order term coefficient and an input value x of a section with respect to the section to which the input value x, an object of square root calculation, belongs, to output a first-order term of an approximate equation, and output a constant term of the section.

Hereinafter, a control signal output from the control signal generator 13, and a method of outputting a first-order term and a constant term at the coefficient storing unit 12 are described in more detail.

The coefficient storing unit 12 can include a first-order term output unit 121 performing an operation on a first-order term of a first-order approximate equation determined for each section by the above-described linear regression analysis, and outputting the same, a first-order constant term output unit 122 outputting a constant term, and a control signal generator 123 generating a control signal for determining outputs of the first-order term output unit 121 and the constant term output unit 122 according to a section to which an input value x, an object of square root calculation, belongs.

The first-order term output unit 121 multiples a coefficient of a first-order term determined for each section by linear regression analysis by an input value x, which is an object of square root calculation, to output the same. The first-order term output unit 121 determines a first-order term coefficient of a relevant section using information regarding the section to which the input value x belongs, provided by a control signal generated at the control signal generator 123, and multiples the determined first-order term coefficient by the input value x to complete the first-order term of the first-order approximate equation. Likewise, the constant term output unit 122 outputs a constant term of the relevant section using information regarding the section to which the input value x belongs, provided by a control signal generated at the control signal generator 123. The values output from the first-order term output unit 121 and the constant term output unit 122 are added by the adder 13, and output as a final square root value for the input value x.

The control signal generator 123 receives information regarding a section to which an input value x belongs, judged by the section judgment unit 11, and provides a corresponding control signal to the first-order term output unit 121 and the constant term output unit 122.

As described above, the first-order term output unit 121 multiplies an input value x by a first-order term coefficient to output the same. In case of using a general multiplier in performing an operation of multiplying an input value x by a first-order term coefficient, the size of the multiplier is large, so that the entire size of a square root calculation apparatus increases. Particularly, in case of having to perform a complicated multiplication operation, the size of a multiplier increases even more. Therefore, according to an embodiment, instead of using a multiplier, multiplication can be performed using a bit movement operation method of bit-moving input values x and adding the bit-moved values.

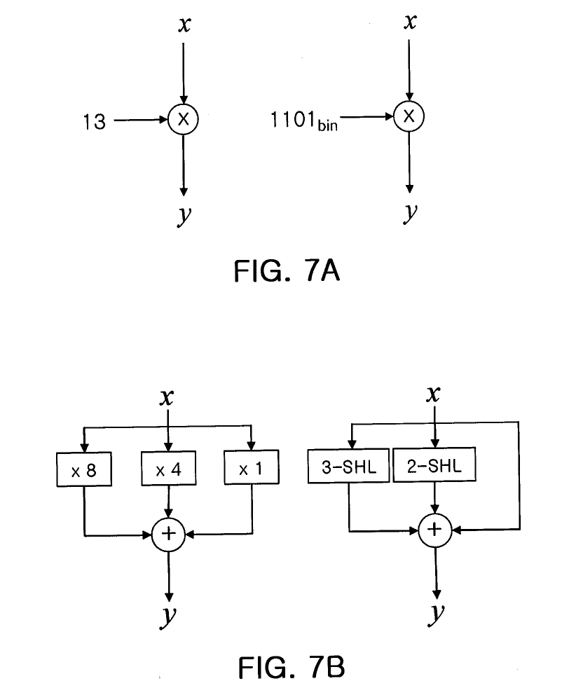

FIGS. 7A and 7B are views schematically explaining the concept of a bit movement operation, and illustrates an example where a simple operation of “y=13x” is performed by applying the bit movement operation. FIG. 7A illustrates a multiplication operation simply using a multiplier. At this point, a number 13 by which an input value x is multiplied is expressed by “1101” in terms of a binary number. In the bit movement operation, a multiplication operation is performed as follows, in which: a number by which an input value is multiplied is expressed by a binary number, the input value is multiplied by respective bit (the position number) of the binary number, and the multiplied values are added. That is, as illustrated in FIG. 7B, an input value x is multiplied by 2³(=8), 2²(=4), and 2⁰(=1), and the multiplied values are added again. At this point, multiplying the input value x by 2³(=8), 2²(=4), and 2⁰(=1) is equivalent to moving an input signal expressed in terms of a binary number to the left (upper bit) by 3 bits, 2 bits, and 0 bit in a binary operation. For example, assuming that an input value x is a binary number 101 (decimal number 5), when the binary number 101 is moved to the left by 3 bits, 101000 (decimal number 40). That is, the result of moving the input value by 3 bits is equivalent to multiplying the input value by 8. As described above, according to the present invention, a multiplication operation is simply performed by bit-moving an input value and adding the results. Accordingly, use of a multiplier can be excluded.

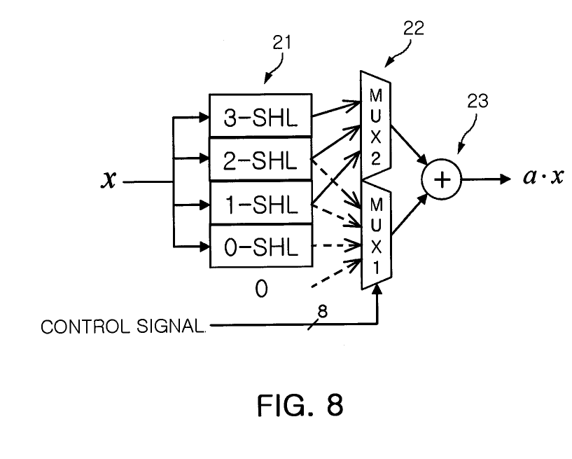

To realize a multiplication operation through this bit-moving operation, as illustrated in FIG. 8, the first-order term output unit 121 can include a bit moving unit 21 moving an input value x to 0 bit through n bits, a multiplexer unit 22 selecting values bit-moved by the bit moving unit 21 in response to a control signal output from the control signal generator 123 and containing information regarding a section to which an input value x belongs, and an adder 23 adding all values output from the multiplexer unit 22. FIG. 8 is a view explaining an example where a multiplication operation is performed using the simple bit moving unit 21 and multiplexing unit 22 in response to a control signal. Referring to FIG. 8, an input value x is bit-moved to an upper bit by 3 bits, 2 bits, 1 bit, and 0 bit by the bit moving unit 21. The multiplexer unit 22 includes two multiplexers MUX1 and MUX2. Each multiplexer selects and outputs the bit-moved values in response to a control signal output from the control signal generator. Table 4 represents an example of outputs of each multiplexer in response to a control signal.

TABLE 4

| MUX2 (7:4) | MUX2 | MUX1 (3:0) | MUX1 |
|---|---|---|---|
| control signal | output | control signal | output |
| 1 (0001) | 2³ · x (3-SHL) | 1 (0001) | 2² · x (2-SHL) |
| 2 (0010) | 2² · x (2-SHL) | 2 (0010) | 2¹ · x (1-SHL) |
| 3 (0011) | 2¹ · x (1-SHL) | 3 (0011) | 2⁰ · x (0-SHL) |
| | | 4 (0100) | 0 |

As illustrated in Table 4, a control signal can include total 8 bits. Upper 4 bits of a control signal is used for controlling an output of the multiplexer MUX2, and lower 4 bits of the control signal is used for controlling the multiplexer MUX1. This relation between the control signal and outputs of the multiplexer unit 22 can be determined in advance so that a first-order term coefficient value in a relevant section is determined and then output. That is, first-order term coefficient values stored inside the coefficient storing unit 12 are stored in the form of determination of a control signal by the control signal generator 123 and a bit-moving value of the multiplexer unit 22 in response to this control signal. For example, a method of realizing first-order terms having first-order term coefficients of 12, 10, 5, and 2 using a control signal is represented in Table 5.

TABLE 5

| | Control | | MUX output | | Final output (a · x) |
|---|---|---|---|---|---|
| | signal | | MUX2 | MUX1 | MUX2 output + |
| Input | MUX2 | MUX1 | output | output | MUX1 output |
| x | 1 | 1 | 2³ · x(3-SHL) | 2² · x(2-SHL) | 2³ · x + 2² · x = 12(1100) · x |
| | 1 | 2 | 2³ · x(3-SHL) | 2¹ · x(1-SHL) | 2³ · x + 2¹ · x = 10(1010) · x |
| | 2 | 3 | 2² · x(2-SHL) | 2⁰ · x(0-SHL) | 2² · x + 2⁰ · x = 5(0101) · x |
| | 3 | 4 | 2¹ · x(1-SHL) | 0 | 2¹ · x = 2(0010) · x |

In the case where a first-order term coefficient in a section to which an input value x belongs is 12, the section judgment 11 outputs information regarding the relevant section to the control signal generator 123. The control signal generator 123 generates a control signal of 0001_{—}0001 set in advance as a control signal of the relevant section according to the section information. When this control signal is input to the multiplexer unit 22, the multiplexer MUX2 of the multiplexer unit 22 selectively outputs 2³·x, i.e., a value moved by 3 bits with reference to the relation (Table 4) between a control signal set in advance and an output, and the multiplexer MUX1 selectively outputs 2²·x, i.e., a value moved by 2 bits. Two values output by the multiplexer unit 22 are added to each other by the adder 23, so that “2³·x+2²·x=12x” is finally output.

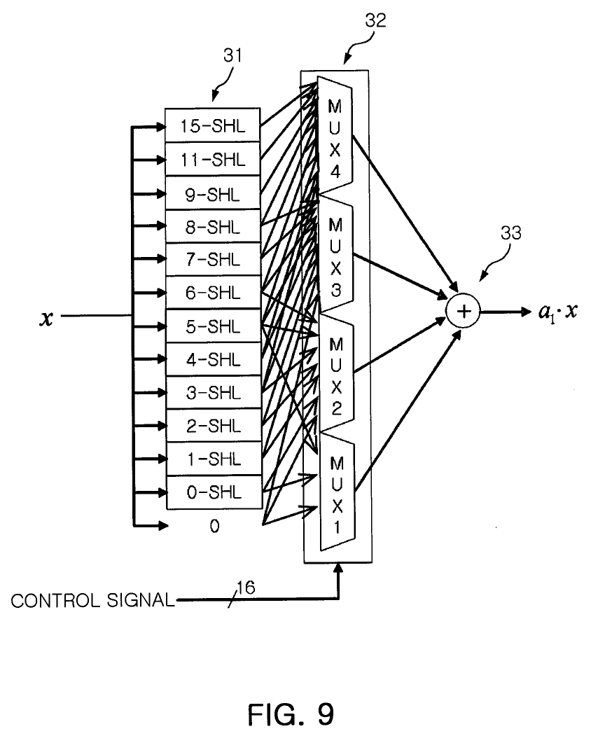

FIG. 9 illustrates a case where the bit moving unit 21, the multiplexer unit 22, and the adder 23 of the above-described first-order term output unit 121 are applied to a 21-bit input signal of Table 3. FIG. 9 illustrates a first-order term output unit that can be configured in the case where an input value is 21 bits, and includes a bit moving unit 31 performing bit movement of 0 through 15 bits on an input value x, a multiplexer unit 32 having a plurality of multiplexers MUX1 through MUX4 selectively outputting a bit-moved value output from the bit moving unit 31 in response to a control signal, and an adder 33 adding all the values output from the multiplexer unit 32. The control signal input to the multiplexer unit 32 can include total 16 bits assigned by 4 bits for each multiplexer. Control signals input to respective multiplexers and bit movement values selectively output in response to the control signals are given by Table 6.

TABLE 6

| MUX4 | | MUX3 | | MUX2 | | MUX1 | |
|---|---|---|---|---|---|---|---|
| Control | MUX4 | Control | MUX3 | Control | MUX2 | Control | MUX1 |
| signal | Output | signal | Output | signal | output | signal | output |
| 1 | 2¹⁵ · x(15-SHL) | 1 | 0 | 1 | 0 | 1 | 0 |
| 2 | 2¹¹ · x(11-SHL) | 2 | 2⁸ · x(8-SHL) | 2 | 2⁵ · x(5-SHL) | 2 | 2⁵ · x(5- |
| | | | | | | | SHL) |
| 3 | 2⁹ · x(9-SHL) | 3 | 2⁷ · x(7-SHL) | 3 | 2⁶ · x(6-SHL) | 3 | 2⁰ · x(0- |
| | | | | | | | SHL) |
| 4 | 2⁸ · x(8-SHL) | 4 | 2⁶ · x(6-SHL) | 4 | 2³ · x(3-SHL). | | |
| 5 | 2⁷ · x(7-SHL) | 5 | 2⁵ · x(5-SHL) | 5 | 2² · x(2-SHL) | | |
| 6 | 2⁶ · x(6-SHL) | 6 | 2⁴ · x(4-SHL) | 6 | 2¹ · x(1-SHL) | | |
| 7 | 2⁵ · x(5-SHL) | 7 | 2³ · x(3-SHL) | 7 | 2⁰ · x(0-SHL) | | |
| 8 | 2⁴ · x(4-SHL) | 8 | 2² · x(2-SHL) | | | | |
| 9 | 2³ · x(3-SHL) | 9 | 2¹ · x(1-SHL) | | | | |

Also, Table 7 represents multiplexer control signals output according to total 31 sections, and Table 8 illustrates first-order terms for respective sections output in response to multiplexer control signals of Table 7.

TABLE 7

MUX control signal

| | MUX4 | MUX3 | MUX2 | MUX1 |
|---|---|---|---|---|
| Section | (15:12) | (11:8) | (7:4) | (3:0) |
| 1 | 1 | 1 | 1 | 1 |
| 2 | 2 | 2 | 2 | 1 |
| 3 | 3 | 2 | 2 | 1 |
| 4 | 4 | 3 | 3 | 2 |
| 5 | 4 | 4 | 1 | 1 |
| 6 | 5 | 4 | 2 | 1 |
| 7 | 5 | 5 | 1 | 1 |
| 8 | 8 | 1 | 1 | 1 |
| 9 | 6 | 5 | 1 | 1 |
| 10 | 6 | 5 | 1 | 1 |
| 11 | 6 | 1 | 1 | 1 |
| 12 | 6 | 1 | 1 | 1 |
| 13 | 6 | 1 | 1 | 1 |
| 14 | 6 | 1 | 1 | 1 |
| 15 | 6 | 1 | 1 | 1 |
| 16 | 7 | 6 | 4 | 1 |
| 17 | 7 | 6 | 1 | 1 |
| 18 | 7 | 7 | 1 | 1 |
| 19 | 7 | 8 | 1 | 1 |
| 20 | 7 | 1 | 1 | 1 |
| 21 | 8 | 7 | 5 | 1 |
| 22 | 8 | 7 | 1 | 1 |
| 23 | 8 | 8 | 6 | 1 |
| 24 | 8 | 8 | 1 | 1 |
| 25 | 8 | 9 | 1 | 1 |
| 26 | 8 | 1 | 1 | 1 |
| 27 | 9 | 8 | 6 | 3 |
| 28 | 9 | 8 | 6 | 1 |
| 29 | 9 | 8 | 7 | 1 |
| 30 | 9 | 8 | 1 | 1 |
| 31 | 9 | 8 | 1 | 1 |

TABLE 8

MUX output

| | MUX4 | MUX3 | MUX2 | MUX1 |
|---|---|---|---|---|
| Section | (15:12) | (11:8) | (7:4) | (3:0) |
| 1 | 2¹⁵ · x | 0 | 0 | 0 |
| 2 | 2¹¹ · x | 2⁸ · x | 2⁵ · x | 0 |
| 3 | 2⁹ · x | 2⁸ · x | 2⁵ · x | 0 |
| 4 | 2⁸ · x | 2⁷ · x | 2⁶ · x | 2⁵ · x |
| 5 | 2⁸ · x | 2⁶ · x | 0 | 0 |
| 6 | 2⁷ · x | 2⁶ · x | 2⁵ · x | 0 |
| 7 | 2⁷ · x | 2⁵ · x | 0 | 0 |
| 8 | 2⁷ · x | 0 | 0 | 0 |
| 9 | 2⁶ · x | 2⁵ · x | 0 | 0 |
| 10 | 2⁶ · x | 2⁵ · x | 0 | 0 |
| 11 | 2⁶ · x | 0 | 0 | 0 |
| 12 | 2⁶ · x | 0 | 0 | 0 |
| 13 | 2⁶ · x | 0 | 0 | 0 |
| 14 | 2⁶ · x | 0 | 0 | 0 |
| 15 | 2⁶ · x | 0 | 0 | 0 |
| 16 | 2⁵ · x | 2⁴ · x | 2³ · x | 0 |
| 17 | 2⁵ · x | 2⁴ · x | 0 | 0 |
| 18 | 2⁵ · x | 2³ · x | 0 | 0 |
| 19 | 2⁵ · x | 2² · x | 0 | 0 |
| 20 | 2⁵ · x | 0 | 0 | 0 |
| 21 | 2⁴ · x | 2³ · x | 2² · x | 0 |
| 22 | 2⁴ · x | 2³ · x | 0 | 0 |
| 23 | 2⁴ · x | 2² · x | 2¹ · x | 0 |
| 24 | 2⁴ · x | 2² · x | 0 | 0 |
| 25 | 2⁴ · x | 2¹ · x | 0 | 0 |
| 26 | 2⁴ · x | 0 | 0 | 0 |
| 27 | 2³ · x | 2² · x | 2¹ · x | 2⁰ · x |
| 28 | 2³ · x | 2² · x | 2¹ · x | 0 |
| 29 | 2³ · x | 2² · x | 2⁰ · x | 0 |
| 30 | 2³ · x | 2² · x | 0 | 0 |
| 31 | 2³ · x | 2² · x | 0 | 0 |

Similarly with the above-described operation of the first-order term output unit 121, the constant term output unit 122 can operate. However, since the constant term output unit 122 does not need to apply the bit movement operation, it can include a constant term storing unit (not shown) directly storing a constant term for each section, determined by the above-described linear regression analysis, and a multiplexer (not shown) selectively outputting a constant term stored in the constant term storing unit in response to a control signal for a section to which an input value belongs, generated by the control signal generator. Table 9 shows control signals for respective sections and output values thereof used in outputting a constant term.

TABLE 9

| Section | |
|---|---|
| (control | MUX output |
| signal) | (constant) |
| 1 (000001) | 0 |
| 2 (000010) | 97 |
| 3 (000011) | 296 |
| 4 (000100) | 526 |
| 5 (000101) | 795 |
| 6 (000110) | 1144 |
| 7 (000111) | 1616 |
| 8 (001000) | 2024 |
| 9 (001001) | 2702 |
| 10 (001010) | 2657 |
| 11 (001011) | 3953 |
| 12 (001100) | 4021 |
| 13 (001101) | 4079 |
| 14 (001110) | 4049 |
| 15 (001111) | 3998 |
| 16 (010000) | 4660 |
| 17 (010001) | 5434 |
| 18 (010010) | 6528 |
| 19 (010011) | 7256 |
| 20 (010100) | 8177 |
| 21 (010101) | 9333 |
| 22 (010110) | 10894 |
| 23 (010111) | 11908 |
| 24 (011000) | 13081 |
| 25 (011001) | 14542 |
| 26 (011010) | 16353 |
| 27 (011011) | 17449 |
| 28 (011100) | 18698 |
| 29 (011101) | 20134 |
| 30 (011110) | 21813 |
| 31 (011111) | 21779 |

A first-order term generated by a bit movement operation by the first-order term output unit 121 and selective output of the multiplexer in response to a control signal for each section, and a constant term output from the constant term output unit 122 in response to a control signal for each section are added by the adder 13, so that an approximated square root value for an input value x is generated and output.

For more clear understanding of the present invention, an entire process of operating an approximated square root value for a real specific input value is described with reference to the above-described drawings and tables.

For example, it is assumed that an input value, which is an object of square root calculation, is “467800”. When this input signal is input to the square root calculation apparatus according to the present invention, the section judgment unit 11 judges a section to which this input signal “467800” belongs. According to Table 1, a section to which the input value “467800” belongs is a section No. 22. When information regarding this section is transferred to the control signal generator 123, the control signal generator 123 generates a control signal to the first-order term output unit 121 and a control signal to the constant term output unit 122. Meanwhile, a bit movement value selected by the first-order term output unit 121 in response to a control signal, and a constant term value output from the constant term output unit 122 in response to a control signal can be determined in advance by calculating a first-order approximate equation for each section using the above-described linear regression analysis and section overlapping method.

A control signal output from the control signal generator 123 to the first-order term output unit 121 is “8(1000)-7(0111)-1(0001)-1(0001)” as shown in Table 7. That is, a control signal provided to the multiplexer MUX4 of the multiplexer unit 31 is 8(1000), a control signal provided to the multiplexer MUX3 is 7(0111), a control signal provided to the multiplexer MUX2 is 1(0001), and a control signal provided to the multiplexer MUX1 is 1(0001). Also, a control signal output from the control signal generator 123 to the constant term output unit 122 is “22(010110” as shown in Table 9. A value indicated inside a bracket in the control signal is a control signal value expressed by a binary number.

A bit moving unit 31 of the first-order term output unit 121 performs a bit movement operation on an input value “467800”. That is, the bit moving unit 31 calculates a value obtained by moving “467800” to an upper bit direction (left) by 0 through 15 bits. The multiplexer unit 32 of the first-order term output unit 121 outputs a 4-bit movement value through the multiplexer MUX4 from bit movement values calculated from the bit moving unit 31 in response to the control signal, outputs a 3-bit movement value through the multiplexer MUX3, and outputs 0 through the multiplexers MUX2 and MUX1 as shown in Tables 6 and 8. That is, the multiplexer MUX4 outputs “2⁴·467800” obtained by moving “467800” by 4 bits, and the multiplexer MUX3 outputs “2³·467800” obtained by moving “467800” by 3 bits. These values are added by the adder 33, so that a first-order term of “11227200” is completed.

Also, the constant term output unit 122 outputs a constant term of “10894” in response to a control signal of “21(010110)” as shown in Table 9.

As described above, a first-order term coefficient multiplied by an input value at the constant term output unit 122 is a value multiplied by 2¹⁵ during a process of integer making, and a constant term is a value multiplied by 2⁵. Therefore, a first-order term of “11227200” output from the constant term output unit 122 is multiplied by 2⁻¹⁵, and a constant term of “10894” is multiplied by 2⁻⁵, and these values are input to the adder. Result values of respective multiplications are rounded off, and then added by the adder 33, so that an approximate square root value of “683” is output.

As described above, according to the present invention, a section is subdivided depending on the size of an input value, and a first-order approximate equation that minimizes an error using linear regression analysis is obtained for each section and applied to square root calculation, so that complexity of square root calculation is reduced and simultaneously accuracy is improved.

Particularly, a section for obtaining a first-order approximate equation is selected such that adjacent sections overlap each other, so that an error between the first-order approximate equation and an exact square root curve can be minimized.

In addition, multiplication of a first-order term coefficient and an input value is performed using a simple bit movement operation method in applying an input value to a first-order approximate equation, so that application of a multiplier is excluded and so a square root calculation apparatus can be miniaturized.

While the present invention has been shown and described in connection with the exemplary embodiments, it will be apparent to those skilled in the art that modifications and variations can be made without departing from the spirit and scope of the invention as defined by the appended claims.

What is claimed is:

1. A square root calculation apparatus comprising:
a section judgment unit storing information regarding a plurality of sections obtained by dividing an entire range of an input value which is an object of square root calculation, into predetermined intervals, and judging one of the sections to which the input value belongs when the input value is input;
a coefficient storing unit storing, in advance, first-order term coefficients and constant terms of first-order approximate equations obtained by approximating square root curves for respective sections, multiplying a first-order term coefficient of the first-order approximate equation in the section to which the input value belongs, judged by the section judgment unit, by the input value to output a first-order term, and outputting a constant term in the section to which the input value belongs, judged by the section judgment unit; and
an adder adding the first-order term and the constant term output from the coefficient storing unit to calculate an approximated square root value.

2. The apparatus of claim 1, wherein a first-order term coefficient and a constant term of a first-order approximate equation in each of the sections are determined by linear regression analysis.

3. The apparatus of claim 1, wherein the first-order approximate equations are calculated by dividing the entire range of the input value into the plurality of sections such that adjacent sections overlap each other, and applying linear regression analysis to respective overlapping sections.

4. The apparatus of claim 3, wherein the plurality of sections stored in the section judgment unit comprise sections divided using intersection points of the first-order approximate equations as boundaries, determined in the overlapping sections adjacent to each other.

5. The apparatus of claim 1, wherein the plurality of sections stored in the section judgment unit have a close interval as an input value is close to zero.

6. The apparatus of claim 1, wherein the coefficient storing unit comprises:
a first-order term output unit selecting a first-order term coefficient for the section to which the input value belongs from the first-order term coefficients of the first-order approximate equations for respective sections, and multiplying the selected first-order term coefficient by the input value to output the same;
a constant term output unit selecting the constant term of the section to which the input value belongs, from the constant terms of the first-order approximate equations for the respective sections to output the same; and
a control signal generator outputting a control signal comprising information regarding the section to which the input value belongs, to the first term output unit and the constant term output unit in order to determine the coefficient in the section to which the input value belongs using the information regarding the section to which the input value belongs.

7. The apparatus of claim 6, wherein the first-order term output unit comprises:
a bit moving unit bit-moving the input value to an upper bit by each number of bits up to a maximum bit set in advance;
a multiplexer unit comprising a plurality of multiplexers selecting some of values bit-moved by the bit moving unit to output the same; and
an adder adding value output from the multiplexer unit,
the control signal comprising information regarding the bit-moved value that is to be selected by the plurality of multiplexers according to the section to which the input value belongs, determined by the section judgment unit.

8. The apparatus of claim 6, wherein the constant term output unit comprises:
a storing unit storing a constant term of a first-order approximate equation according to the section; and
a multiplexer selecting the constant term of the first-order approximate equation in the section to which the input value belongs, from the storing unit, and outputting the same in response to the control signal.
